(19) United States
(12) Patent Application Publication
(10) Pub. No.: US 2002/0144141 A1
(43) Pub. Date: Oct. 3, 2002

(54) Countering buffer overrun security vulnerabilities in a CPU

(76) Inventors: James W. Edwards, Portland, OR (US); Frederick W. Strahm, Hillsboro, OR (US); John W. Richardson, Portland, OR (US); Ylian Saint-Hilaire, Hillsboro, OR (US)

Correspondence Address: Michael A. DeSanctis, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/823,491

(22) Filed: Mar. 31, 2001

(51) Int. Cl. G06F 11/30; G06F 12/14

(52) U.S. Cl. 713/200

(57) ABSTRACT

A method and apparatus are described for preventing security vulnerabilities resulting from buffer overruns. According to one embodiment of the present invention, CALL is modified to place a return address on the stack, and then a random amount of space is added to the stack. This random value is placed in a known place on the stack, or kept in a non-accessible CPU register. The rest of the stack is built normally. When RET is called it finds the number of bytes added to the stack and finds the return address on the stack and returns as normal. This method allows a simple hardware solution that will not be visible to the software, yet provide a powerful deterrent to hackers looking to exploit buffer overrun vulnerabilities in software. Without any software modifications we would be able to deter a significant number of buffer overrun attacks. By affecting components lower on the environment it is possible to influence a larger set of software. For example, it is possible to affect all of the software running on the system without having to change any of the software.

### FIELD OF THE INVENTION

The invention relates generally to the field of computer operating system security. More particularly, the invention relates to preventing security vulnerabilities resulting from buffer overruns.

### BACKGROUND OF THE INVENTION

It is well known that buffer overrun errors are the most common form of errors on the Internet today. Intentional use of buffer overrun errors to attack a system is commonly known as “stack smashing”. Such attacks can cause a system crash, corrupt data, or allow an attacker to execute malicious code on a target machine.

FIG. 1 is a block diagram illustrating a typical stack. This example depicts a stack 100 after a function has been called. Here, arguments 105, a return address 110, a previous frame pointer 115, and local variables 120 have been placed on the stack 100. The stack 100 also contains a buffer 125 into which data will be placed.

A stack smashing attack normally occurs by overrunning this buffer 125. A piece of code may contain a string array and allow user input into the array without checking the size of the data entered. For example, an application may contain a fixed string array of 10 characters. Therefore, the buffer will contain space for these 10 characters. If more than 10 characters are written into the array, the buffer 125 will overflow. Once the buffer 125 overflows, the local variables 120, previous frame pointer 115, and return address 110 will be overwritten. Vulnerability occurs when the return address 110 is overwritten. This causes processing to jump back to an unintended location after execution of the called function is finished. In some cases, by placing into the buffer 125 data indicating a specific address, cause processing to return to and execute malicious code that had previously been stored there.

One of the current solutions involve changing the way a programmer writes code. That is, a programmer should avoid code that allows a user to write data onto the stack without validation. However, this solution only works if programmers consistently write code that does not violate this rule. Another possible solution is to produce compilers that can prevent code from being written in violation of this rule. However, such a solution would likely not be fool proof and compiler settings may be changed to disable such safeguards. Another defense is to limit access to the stack by making portions such as the local variables 120, previous frame pointer 115, and others inaccessible. This solution however limits flexibility since it limits the ability of self-modifying code to place snippets of code onto the stack.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1 is a block diagram illustrating a typical stack;

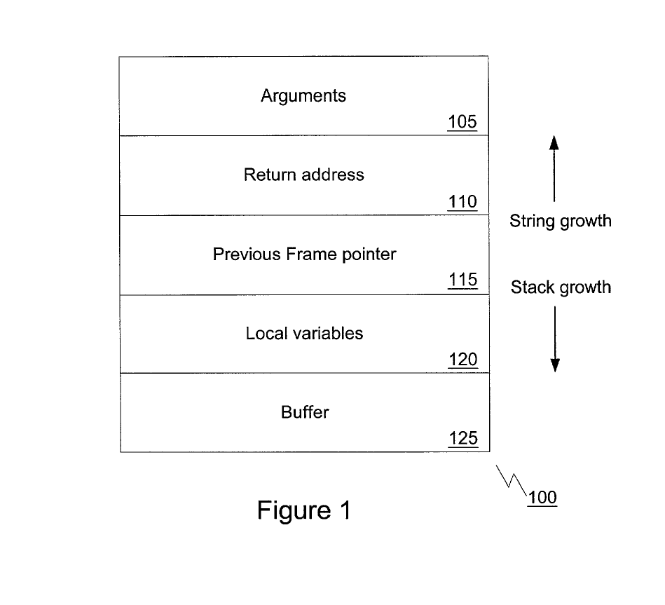

FIG. 2 is a block diagram illustrating an example of a typical computer system upon which embodiments of the present invention may be implemented;

FIG. 3 is a flowchart illustrating a high-level view of countering buffer overrun security vulnerabilities according to one embodiment of the present invention;

FIG. 4 is a flowchart illustrating function call processing according to one embodiment of the present invention;

FIG. 5 is a flowchart illustrating function return processing according to one embodiment of the present invention;

FIG. 6 is a flowchart illustrating function call processing according to one embodiment of the present invention;

FIG. 7 is a flowchart illustrating function return processing according to one embodiment of the present invention; and

FIG. 8 is a flowchart illustrating load or install processing according to one embodiment of the present invention.

### DETAILED DESCRIPTION OF THE INVENTION

A method and apparatus are described for preventing security vulnerabilities resulting from buffer overruns. According to one embodiment of the present invention, CALL is modified to place a return address on the stack, and then a random amount of space is added to the stack. This random value is placed in a known place on the stack, or kept in a non-accessible CPU register. The rest of the stack is built normally. When RET is called it finds the number of bytes added to the stack and finds the return address on the stack and returns as normal. This method allows a simple hardware solution that will not be visible to the software, yet provide a powerful deterrent to hackers looking to exploit buffer overrun vulnerabilities in software. Without any software modifications we would be able to deter a significant number of buffer overrun attacks. By affecting components lower on the environment it is possible to influence a larger set of software. For example, it is possible to affect all of the software running on the system without having to change any of the software.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various methods, which will be described below. The methods of the present invention may be performed by hardware components or may be embodied in machine-executable instructions, which may be used to cause a general-purpose or special-purpose processor or logic circuits programmed with the instructions to perform the methods. Alternatively, the methods may be performed by a combination of hardware and software.

The present invention may be provided as a computer program product that may include a machine-readable medium having stored thereon instructions that may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

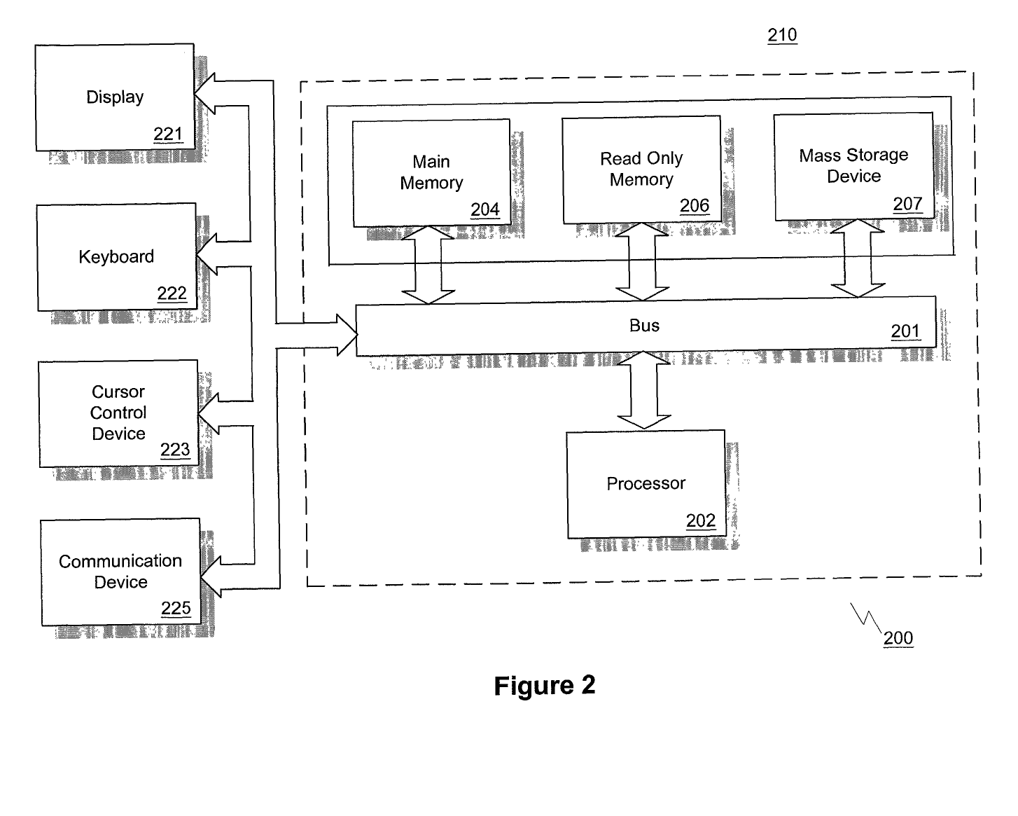

FIG. 2 is a block diagram illustrating an example of a typical computer system upon which embodiments of the present invention may be implemented. Computer system 200 comprises a bus or other communication means 201 for communicating information, and a processing means such as processor 202 coupled with bus 201 for processing information. Computer system 200 further comprises a random access memory (RAM) or other dynamic storage device 204 (referred to as main memory), coupled to bus 201 for storing information and instructions to be executed by processor 202. Main memory 204 also may be used for storing temporary variables or other intermediate information during execution of instructions by processor 202. Computer system 200 also comprises a read only memory (ROM) and/or other static storage device 206 coupled to bus 201 for storing static information and instructions for processor 202.

A data storage device 207 such as a magnetic disk or optical disc and its corresponding drive may also be coupled to computer system 200 for storing information and instructions. Computer system 200 can also be coupled via bus 201 to a display device 221, such as a cathode ray tube (CRT) or Liquid Crystal Display (LCD), for displaying information to an end user. Typically, an alphanumeric input device 222, including alphanumeric and other keys, may be coupled to bus 201 for communicating information and/or command selections to processor 202. Another type of user input device is cursor control 223, such as a mouse, a trackball, or cursor direction keys for communicating direction information and command selections to processor 202 and for controlling cursor movement on display 221.

A communication device 225 is also coupled to bus 201. The communication device 225 may include a modem, a network interface card, or other well-known interface devices, such as those used for coupling to Ethernet, token ring, or other types of physical attachment for purposes of providing a communication link to support a local or wide area network, for example. In this manner, the computer system 200 may be coupled to a number of clients and/or servers via a conventional network infrastructure, such as a company's Intranet and/or the Internet, for example.

It is appreciated that a lesser or more equipped computer system than the example described above may be desirable for certain implementations. Therefore, the configuration of computer system 200 will vary from implementation to implementation depending upon numerous factors, such as price constraints, performance requirements, technological improvements, and/or other circumstances.

It should be noted that, while the steps described herein may be performed under the control of a programmed processor, such as processor 202, in alternative embodiments, the steps may be fully or partially implemented by any programmable or hard-coded logic, such as Field Programmable Gate Arrays (FPGAs), TTL logic, or Application Specific Integrated Circuits (ASICs), for example. Additionally, the method of the present invention may be performed by any combination of programmed general-purpose computer components and/or custom hardware components. Therefore, nothing disclosed herein should be construed as limiting the present invention to a particular embodiment wherein the recited steps are performed by a specific combination of hardware components.

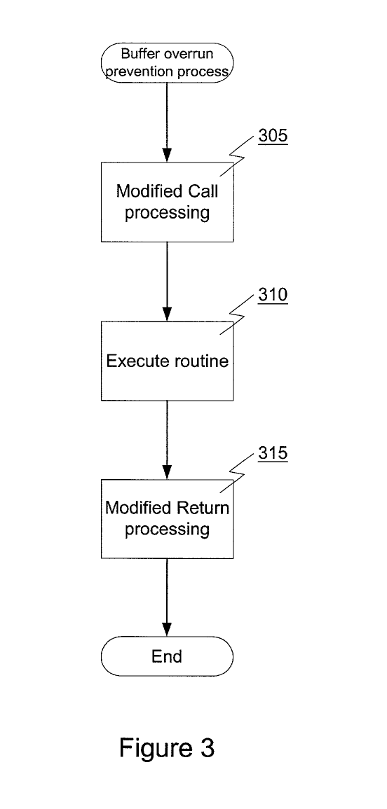

FIG. 3 is a flowchart illustrating a high-level view of countering buffer overrun security vulnerabilities according to one embodiment of the present invention. Generally, CALL is modified to place a return address on the stack, and then a random amount of space is added to the stack. This random value is placed in a known place on the stack, or kept in a non-accessible CPU register. The rest of the stack is built normally. When RET is called it finds the number of bytes added to the stack and finds the return address on the stack and returns as normal.

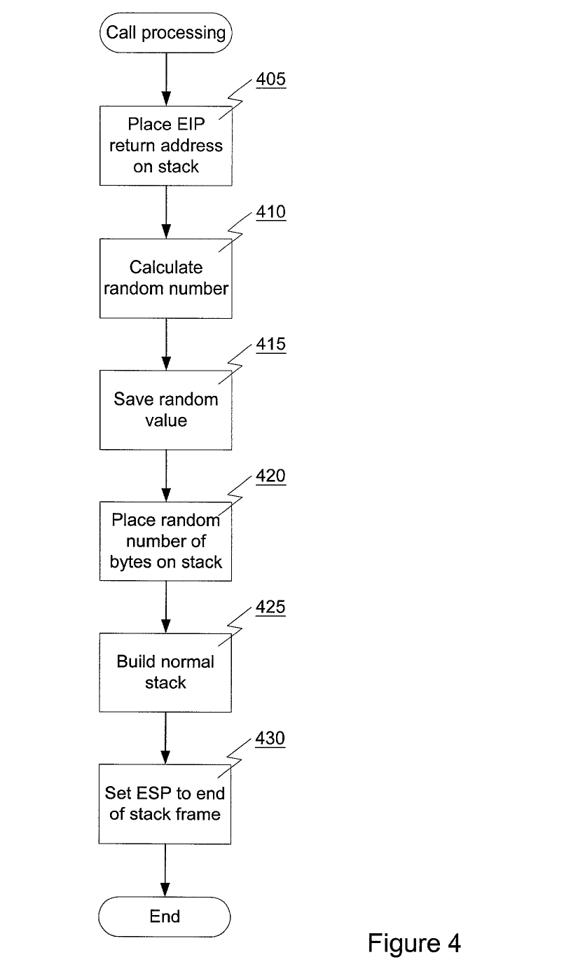

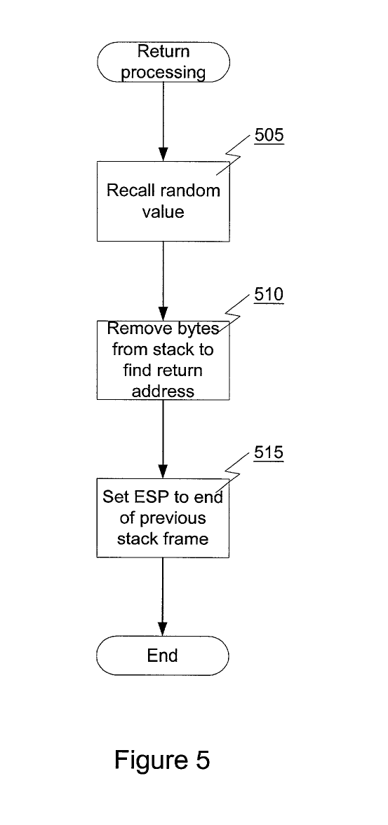

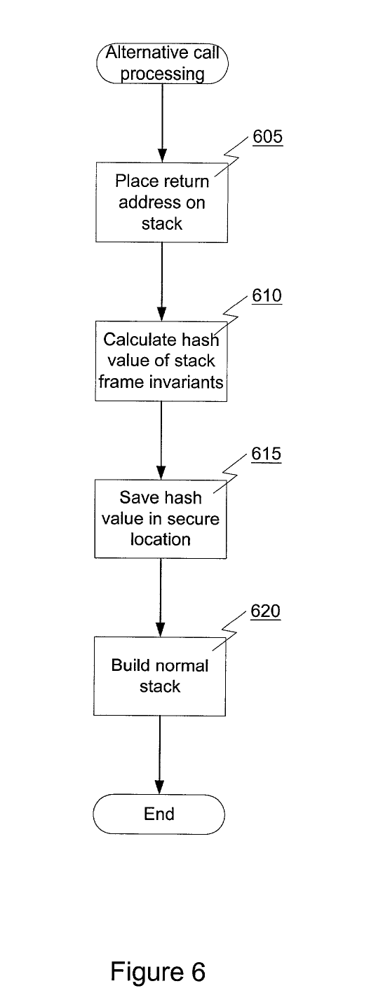

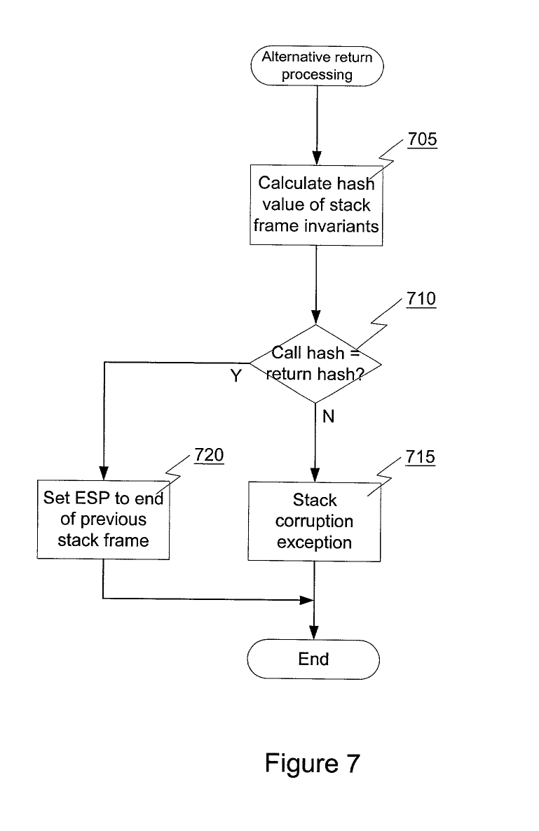

As illustrated in FIG. 3, the modified CALL procedure is executed at processing block 305. Details of this processing will be described below with reference to FIG. 4 and 6. The CALL processing starts the procedure or function called which is then executed at processing block 310. When the called function is finished executing, the modified RET procedure is executed at processing block 315. Details of this processing will be discussed in greater detail below with reference to FIGS. 5 and 7.

This method makes it significantly more difficult for stack overruns to have an adverse result on the machine. The hope would be that a large percentage of the time the running application would encounter an invalid return pointer in the stack frame causing the application to terminate, rather than allowing the inserted code to run causing a security vulnerability. By crashing the application the system administrator can know that their system is under attack and take appropriate defenses before restarting the application in question and continuing on.

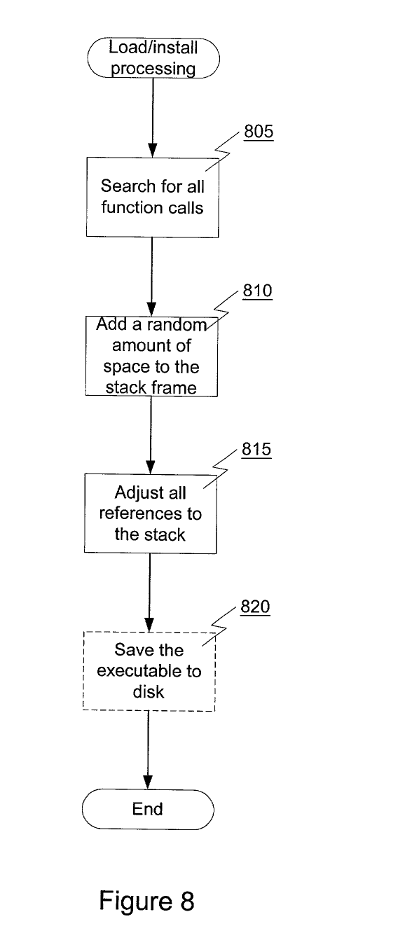

FIG. 4 is a flowchart illustrating function call processing according to one embodiment of the present invention. First, at processing block 405, the appropriate return address is placed on the stack. Next, at processing block 410, a random number is calculated and the number is saved at processing block 415. This number may be saved on the stack or in a register on the processor that is not generally accessible. At processing block 420, a number of bytes of blank space is placed onto the stack equal to the random number. A stack is then built normally at processing block 425. Finally, at processing block 430, an end of stack pointer is set to the end of the stack frame. This embodiment could be inserted either at compile time by an optimized compiler or even at load time by having the loader find all function entry and exit points and inserting a call to the function that is inserted by the loader. An example of such a process is discussed in greater detail below with reference to FIG. 8.

FIG. 5 is a flowchart illustrating function return processing according to one embodiment of the present invention. In this example the random number saved during call processing is recalled at processing block 505. Next, at processing block 510, the number of blank spaces added during call processing are removed from the stack to find the return address. Finally, at processing block 515, the end of stack pointer is set to the end of the previous stack frame.

The modified call and return processing, combined allow for a simple hardware solution that will not be visible to the software, yet provide a powerful deterrent to hackers looking to exploit buffer overrun vulnerabilities in software. Without any software modifications it is possible to deter a significant number of buffer overrun attacks.

FIG. 6 is a flowchart illustrating function call processing according to one embodiment of the present invention. This embodiment replaces call/ret sequences with calls to subroutines that are capable of more sophisticated processing, including hashing invariant parts of the stack frame like return address and verifying that the stack frame has not been corrupted.

As illustrated by FIG. 6, a return address is placed on the stack at processing block 605. Next, at processing block 610 a hash value of stack frame invariants is calculated. At processing block 615 the hash value is saved in a secure location such as a register on the processor that is not generally accessible. Finally, a stack is built normally at processing block 620.

This embodiment could be inserted either at compile time by an optimized compiler or even at load time by having the loader find all function entry and exit points and inserting a call to the function that is inserted by the loader. An example of such a process is discussed in greater detail below with reference to FIG. 8.

FIG. 7 is a flowchart illustrating function return processing according to one embodiment of the present invention. First, at processing block 705, a hash value of stack frame invariants is calculated. This calculation uses the same hash function and same stack frame invariants as the hash function in call processing. Next, at decision block 710, the call hash value saved during call processing is compared to the return hash value. If the hash values match, the end of stack pointer is set to the end of the previous stack frame at processing block 720. If the hash values do not match, a stack corruption exception is executed at processing block 715.

FIG. 8 is a flowchart illustrating load or install processing according to one embodiment of the present invention Here, at either executable load or install time, a search is performed for all function calls at processing block 805. At processing block 810 a random amount of space is added to the stack frame at each function call. All references to the stack are then adjusted at processing block 815 to compensate for the added space. If this process is performed during executable installation, the executable is then saved to disk at optional processing block 820.

Various software and hardware embodiments will have very different performance issues. For example, calling a function on every function entry and exit will add significant processor overhead, but also provide a huge guarantee that the stack frame is completely intact. Making modifications at load time will allow a different version of the application to run each time it is executed at the cost of having to add and compensate for blank space added to the stack every time the executable is loaded, leading to significantly longer load times. Tradeoffs can be made between time and reliability depending on specific system requirements.

What is claimed is:

1. A method of preventing buffer overrun security vulnerabilities comprising:
executing a modified call routine for placing a random amount of empty space onto a stack;
executing a called function; and
executing a modified return routine for removing said random amount of empty space from the stack.

2. The method of claim 1, wherein said modified call routine comprises:
placing a return address for the called function on the stack;
calculating a random number;
saving said random number in a secure location;
placing a plurality of blank bytes equal to the random number onto the stack;
building a stack frame by placing values from the called function onto the stack; and
setting an end of stack pointer to an end of the stack frame.

3. The method of claim 2, wherein said location is a processor register that is not generally accessible.

4. The method of claim 1, wherein said modified return routine comprises:
recalling a random number saved during an execution of said modified call routine;
removing a number of bytes equal to said random number from the stack;
retrieving a return address for the called function from the stack; and
setting an end of stack pointer to an end of a previous stack frame.

5. The method of claim 1, wherein said modified call routine comprises:
placing a return address for the called function on the stack;
calculating a hash value of stack invariants;
saving said hash value in a secure location; and
building a stack frame by placing values from the called function onto the stack.

6. The method of claim 5, wherein said secure location is a processor register that is not generally accessible.

7. The method of claim 1, wherein said modified return routine comprises:
calculating a second hash value of stack invariants;
determining whether said second hash value matches a first hash value calculated during an execution of said modified call routine;
executing a stack corruption exception if said second hash value does not match said first hash value; and
setting an end of stack pointer to an end of a previous stack frame if said second hash value matches said first hash value.

8. A method of preventing buffer overrun security vulnerabilities comprising:
searching an executable program for all function calls at the time the executable is installed;
adding a random amount of blank space to all stacks generated by said function calls;
adjusting all references to said stacks to compensate for said blank space.

9. The method of claim 8, wherein said method is performed when said executable is installed.

10. The method of claim 9, further comprising saving said executable.

11. The method of claim 8, wherein said method is performed when said executable is loaded.

12. An apparatus comprising:
a storage device having stored therein one or more routines for preventing buffer overrun security vulnerabilities; and
a processor coupled to the storage device for executing the one or more routines that, when executing the routines, prevents buffer overrun errors by:
executing a modified call routine for placing a random amount of empty space onto a stack;
executing a called function; and
executing a modified return routine for removing said random amount of empty space from the stack.

13. The apparatus of claim 12, wherein said modified call routine comprises:
placing a return address for the called function on the stack;
calculating a random number;
saving said random number in a secure location;
placing a plurality of blank bytes equal to the random number onto the stack;
building a stack frame by placing values from the called function onto the stack; and
setting an end of stack pointer to an end of the stack frame.

14. The apparatus of claim 13, wherein said location is a processor register that is not generally accessible.

15. The apparatus of claim 12, wherein said modified return routine comprises:
recalling a random number saved during an execution of said modified call routine;
removing a number of bytes equal to said random number from the stack;
retrieving a return address for the called function from the stack; and
setting an end of stack pointer to an end of a previous stack frame.

16. The apparatus of claim 12, wherein said modified call routine comprises:
placing a return address for the called function on the stack;
calculating a hash value of stack invariants;
saving said hash value in a secure location; and
building a stack frame by placing values from the called function onto the stack.

17. The apparatus of claim 16, wherein said secure location is a processor register that is not generally accessible.

18. The apparatus of claim 12, wherein said modified return routine comprises:
calculating a second hash value of stack invariants;
determining whether said second hash value matches a first hash value calculated during an execution of said modified call routine;
executing a stack corruption exception if said second hash value does not match said first hash value; and
setting an end of stack pointer to an end of a previous stack frame if said second hash value matches said first hash value.

19. An apparatus comprising:
a storage device having stored therein one or more routines for preventing buffer overrun security vulnerabilities; and
a processor coupled to the storage device for executing the one or more routines that, when executing the routines, prevents buffer overrun errors by:
searching an executable program for all function calls at the time the executable is installed;
adding a random amount of blank space to all stacks generated by said function calls;
adjusting all references to said stacks to compensate for said blank space.

20. The apparatus of claim 19, wherein said method is performed when said executable is installed.

21. The apparatus of claim 20, further comprising saving said executable.

22. The apparatus of claim 19, wherein said method is performed when said executable is loaded.

23. A machine-readable medium having stored thereon data representing sequences of instructions, said sequences of instructions which, when executed by a processor, cause said processor to prevents buffer overrun errors by:
executing a modified call routine for placing a random amount of empty space onto a stack;
executing a called function; and
executing a modified return routine for removing said random amount of empty space from the stack.

24. The machine-readable medium of claim 23, wherein said modified call routine comprises:
placing a return address for the called function on the stack;
calculating a random number;
saving said random number in a secure location;
placing a plurality of blank bytes equal to the random number onto the stack;
building a stack frame by placing values from the called function onto the stack; and
setting an end of stack pointer to an end of the stack frame.

25. The machine-readable medium of claim 24, wherein said location is a processor register that is not generally accessible.

26. The machine-readable medium of claim 23, wherein said modified return routine comprises:
recalling a random number saved during an execution of said modified call routine;
removing a number of bytes equal to said random number from the stack;
retrieving a return address for the called function from the stack; and
setting an end of stack pointer to an end of a previous stack frame.

27. The machine-readable medium of claim 23, wherein said modified call routine comprises:
placing a return address for the called function on the stack;
calculating a hash value of stack invariants;
saving said hash value in a secure location; and
building a stack frame by placing values from the called function onto the stack.

28. The machine-readable medium of claim 27, wherein said secure location is a processor register that is not generally accessible.

29. The machine-readable medium of claim 23, wherein said modified return routine comprises:
calculating a second hash value of stack invariants;
determining whether said second hash value matches a first hash value calculated during an execution of said modified call routine;
executing a stack corruption exception if said second hash value does not match said first hash value; and
setting an end of stack pointer to an end of a previous stack frame if said second hash value matches said first hash value.

30. A machine-readable medium having stored thereon data representing sequences of instructions, said sequences of instructions which, when executed by a processor, cause said processor to prevents buffer overrun errors by:
searching an executable program for all function calls at the time the executable is installed;
adding a random amount of blank space to all stacks generated by said function calls;
adjusting all references to said stacks to compensate for said blank space.

31. The machine-readable medium of claim 30, wherein said method is performed when said executable is installed.

32. The machine-readable medium of claim 31, further comprising saving said executable.

33. The machine-readable medium of claim 30, wherein said method is performed when said executable is loaded.
